(19) United States
(12) Patent Application Publication
(10) Pub. No.: US 2009/0107819 A1
(43) Pub. Date: Apr. 30, 2009

(54) Secondary Handle Assembly and Method for Actuating a Circuit Breaker

(76) Inventors: Chandrasekhar Samudrikam, Andhra Pradesh (IN); Kumar Natarajan, Chennai (IN); Dhirendra Tiwari, New Britain, CT (US)

Correspondence Address: General Electric Company;GE Global Patent Operation, PO Box 861, 2 Corporate Drive, Suite 648, Shelton, CT, 06484, US

(21) Appl. No.: 11/924,216

(22) Filed: Oct. 25, 2007

(51) Int. Cl. H01H 3/08

(52) U.S. Cl. 200/336

(57) ABSTRACT

A secondary handle assembly for a circuit breaker includes an actuator shaft for actuating a circuit breaker. The actuator shaft extends through a circuit breaker cabinet and terminates at a primary handle assembly. The secondary handle assembly further includes a hub that intern has a handle extending from the hub. A gear wheel is also provided that has gear wheel teeth and a body fixable with the actuator shaft. The hub is configured to engage the gear wheel for rotational movement in one direction in an unactuated position, and the hub is further configured to engage the gear wheel for rotational movement in opposing rotational directions in an actuated position. A method of actuating a circuit breaker is also presented.

### BACKGROUND OF THE INVENTION

1. Field of the Invention

The subject matter described herein relates generally to circuit breakers and, more particularly, to manual actuation of a circuit breaker.

2. Related Art

Electrical controls such as circuit breakers are typically mounted in a cabinet-style enclosure. Handle operators located on the inside of such cabinets, also known as secondary handle operators, must satisfy NFPA79 requirements. One requirement mandates that when the enclosure door is opened to access electrical equipment, the power to the equipment must be turned “off”. However, when the enclosure door is open, it may be desirable to again apply power to the electrical equipment in the cabinet. Another requirement mandates that for the power to be turned “on” while the enclosure door is open, a deliberate action is required by a qualified person. An interlock mechanism may be provided to satisfy such requirements.

U.S. Pat. No. 6,974,922 entitled “Rotary Service Switch for the Interior of Electrical Enclosures having a Disconnect Switch” describes such an interlock mechanism. The device includes a rotor, which is rotatably coupled to a base, that is first axially depressed and then rotated to switch the disconnect switch into the “on” position. The base has a stop member for latching the rotor in an “off” position before the rotor is axially depressed. While this rotary service switch satisfies NFPA79 requirements, a simpler device with fewer components, and that is safe to operate, is desirable.

### BRIEF DESCRIPTION OF THE INVENTION

In accordance with an embodiment of the present invention, a secondary handle assembly for a circuit breaker comprises an actuator shaft for actuating a circuit breaker. The actuator shaft extends through a circuit breaker cabinet and terminates at a primary handle assembly. The secondary handle assembly further comprises a hub that intern comprises a handle extending from the hub. A gear wheel is also provided that comprises gear wheel teeth and a body fixable with the actuator shaft. The hub is configured to engage the gear wheel for rotational movement in one direction in an unactuated position, and the hub is further configured to engage the gear wheel for rotational movement in opposing rotational directions in an actuated position.

In another embodiment of the invention, a method of actuating a circuit breaker comprises an actuator shaft using a secondary handle assembly. The secondary handle assembly comprises a hub that intern comprises a handle extending from the hub. The secondary handle further comprises a gear wheel that intern comprises a body secured to the actuator shaft and gear wheel teeth. The method comprises rotating the handle whereby the hub engages the gear wheel for rotational movement solely in one direction. The method further comprises rotating the handle while moving the handle in a linear direction whereby the hub engages the gear wheel for rotational movement in opposing rotational directions.

### BRIEF DESCRIPTION OF THE DRAWINGS

The following detailed description is made with reference to the accompanying drawings, in which:

FIG. 1 is perspective view of a circuit breaker including secondary handle assembly in accordance with one embodiment of the present invention installed in an electrical enclosure;

FIG. 2 is an exploded view of the secondary handle assembly of FIG. 1;

FIG. 2A is a perspective view of a hub included in the secondary handle assembly of FIGS. 1 and 2;

FIG. 2B is a perspective view of a gear wheel included in the secondary handle assembly of FIGS. 1 and 2;

FIG. 2C is a perspective view of a cap included in the secondary handle assembly of FIGS. 1 and 2;

FIG. 3 is a perspective view of the secondary handle assembly, as seen in FIG. 2, as assembled;

FIG. 3A is a cross-sectional view along line A-A in FIG. 3 of the secondary handle assembly connected to an actuator shaft of the circuit breaker shown in FIG. 1;

FIG. 4 is a perspective view of a secondary handle assembly in an unactuated Position A;

FIG. 5 is a perspective view of a secondary handle assembly in an actuated Position B;

FIG. 6 is an exploded view, in perspective, of a secondary handle assembly in accordance with another embodiment of the present invention;

FIG. 7 is a perspective view of the secondary handle assembly, shown in FIG. 6, as assembled;

FIG. 7A is an enlarged view of a portion of the secondary handle assembly, of FIG. 7;

FIG. 8 is a top view of the secondary handle assembly of FIG. 7; and

FIG. 9 is a side view of the secondary handle assembly of FIG. 7.

### DETAILED DESCRIPTION OF THE PREFERRED EMBODIMENT

An embodiment of the present invention concerns a device and a method for manually actuating a circuit breaker that employs few components and that is safe to operate. The device comprises a secondary handle assembly for the circuit breaker that is configured for manual rotational movement in one direction when in an unactuated position and for movement in opposing rotational directions when in an actuated position. The secondary handle assembly comprises a hub including a handle and a gear wheel rotatable by the hub and fixable with an actuator shaft of the circuit breaker.

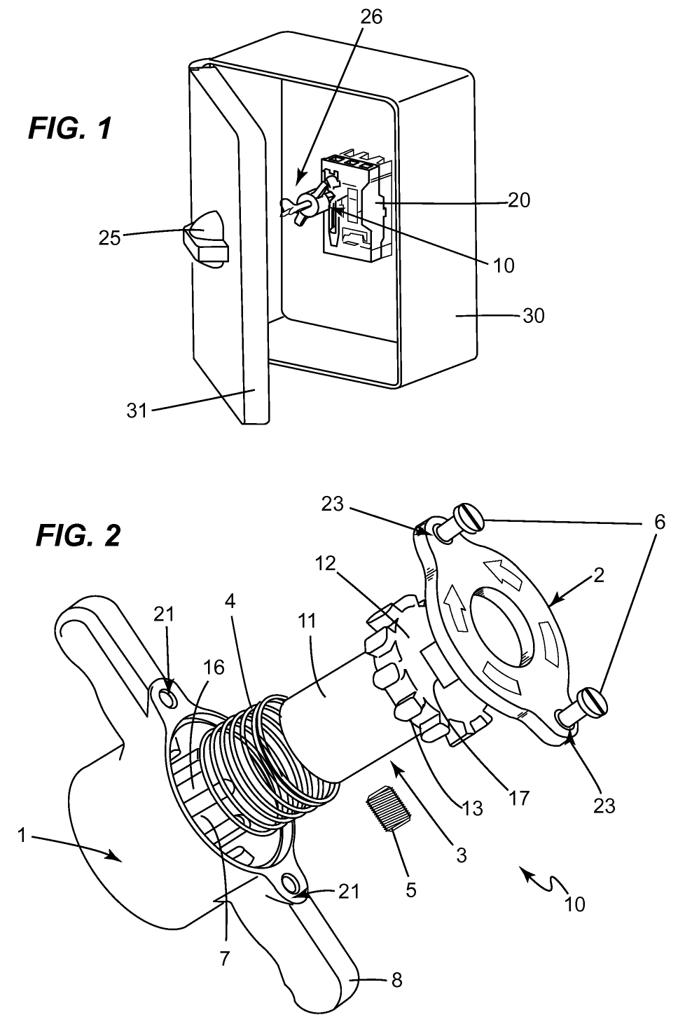

FIG. 1 illustrates a circuit breaker 20, which is mounted in the interior of a cabinet enclosure 30. The enclosure 30 includes a door 31 that, in an open condition, provides access to the interior of cabinet 30. A primary handle assembly 25 on the front of door 31 is interlocked with actuator shaft 26 when door 31 is in a closed condition. When door 31 is in a closed condition, the circuit breaker 20 may be energized or “on”. When primary handle assembly 25 is rotated to open door 31 of enclosure 30, electrical energy to circuit breaker 20 is disconnected or “off”. When door 31 is open, it may be desirable to again apply power to circuit breaker 20 and other electrical control equipment (not shown) in enclosure 30.

Still referring to FIG. 1, a secondary handle assembly 10, in accordance with one embodiment of the present invention, is mounted to the circuit breaker 20 installed inside enclosure 30 in a predetermined location as shown. Secondary handle assembly 10 may be operated when door 31 is open in order to apply power to circuit breaker 20 and other electrical control equipment (not shown) in enclosure 30.

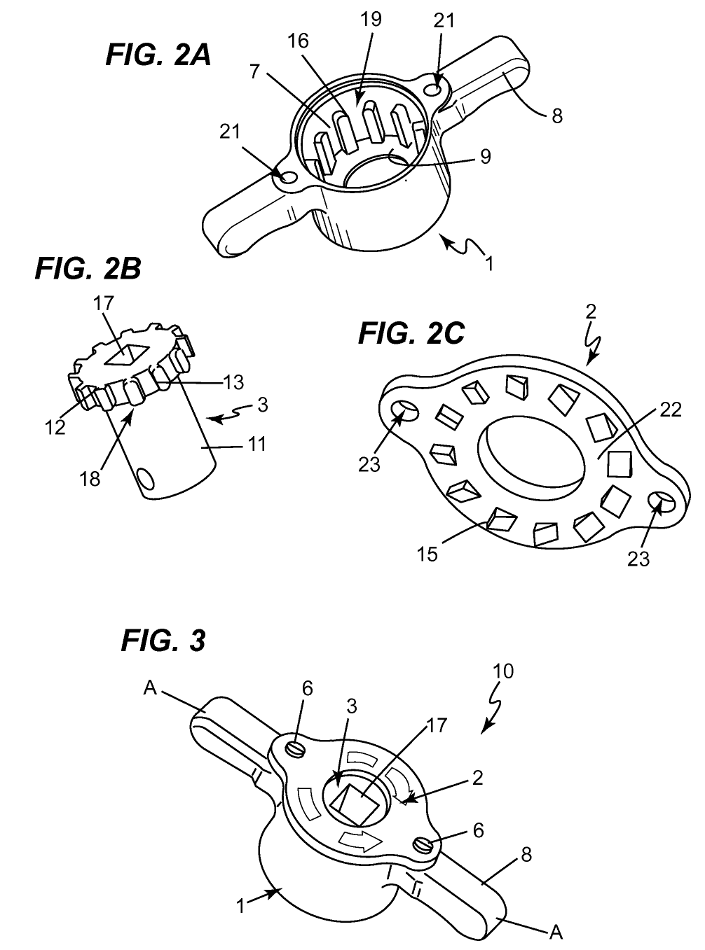

As seen in FIG. 2, secondary handle assembly 10 includes a hub 1 and gear wheel 3. Hub 1 includes a handle 8, which comprises arms (not numbered) extending in opposing radial directions from hub 1. Handle 8 provides a gripping mechanism for operation of secondary handle assembly 10 and may include indicia for operating secondary handle assembly 10 as shown in FIG. 2A.

Referring back to FIG. 2, cap 2 is fixed on hub with screws 6. Screws 6 fit through cap apertures 23 and hub apertures 21. Cap 2 may also include indicia as shown and cap 2, hub 1, handle 8, and gear wheel 3 may each comprise a moldable and insulative substance such as a polymeric substance, for example, a polyamide, Polybutylene Terephthalate (PBT)/Polyethylene Terephthalate (PET)/Polycarbonate (PC) based resins, or moldable non-insulative metals including aluminum alloys with insulative coating or standard organic finish.

Referring to FIG. 2C, cap inner surface 22 comprises teeth 15, which mesh with gear teeth 13 (FIG. 2B) when assembly 10 is not in an actuated position. Therefore, in a non-actuated position, gear wheel 3 is biased adjacent hub 1 and in direct contact with cap 2. Cap teeth 15 may be angled in one direction to create a ratcheting-type connection between hub 1 and gear wheel 3 that allows for handle assembly 10 rotation in one direction when the handle assembly 10 is in the unactuated position.

As seen in FIG. 2B, gear wheel 3 comprises terminal ends and a generally cylindrical outer configuration. One terminal end of gear wheel 3 comprises gear body 11 and the other terminal end comprises gear ring 12. The outer diameter of gear ring 12 is larger than the outer diameter of gear body 11. As a result, compression spring 4, which fits over gear body 11, is stopped by gear ring 12.

FIG. 2 shows that gear wheel 3 and compression spring 4, as assembled above, fit inside the bore of hub 1. Therefore, compression spring 4 fits in between gear shaft 11 and hub inner surface 7. As seen in FIG. 2A, lip 9 runs along the base of hub inner surface 7 and acts as another stop for spring 4. Lip 9 prevents spring 4 from slipping past the base of hub 1 and acts as an alignment portion for secondary handle assembly 10.

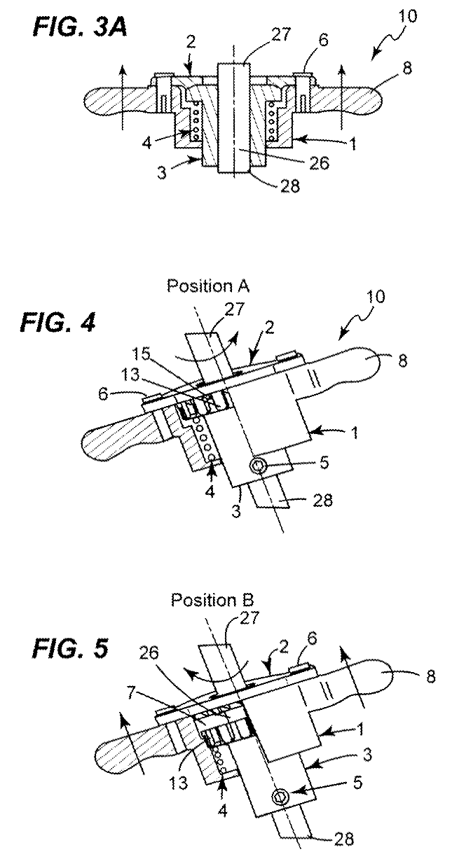

Referring back to FIG. 2, shaft 26 (not shown) fits inside assembly 10 through gear wheel aperture 17. Gear wheel 3 may be fixed to shaft 26 with setscrew 5. FIG. 3 shows secondary handle 10 as assembled.

FIG. 3A shows a cross-sectional view along line A-A of assembled secondary handle 10 around shaft 26. Shaft 26 includes door end 27, which is coupled to primary handle assembly 25 (FIG. 1) when door 31 is in a closed condition. Shaft 26 further includes breaker end 28. Breaker end 28 remains engaged to circuit breaker 20 when door 31 is in a closed or open position. To apply power to circuit breaker 20 when door 31 is open, an axial and rotational force is applied to secondary handle assembly 10. Actuator shaft 26, rigidly coupled to secondary handle assembly 10, responds to the applied forces and actuates circuit breaker 20.

FIG. 4 is a view of secondary handle assembly 10 in an unactuated position. This position is also referred to as Position A. Spring 4 keeps assembly 10 in Position A regardless of door 31 condition. Position A is the normal position of assembly 10 before axial and/or an appropriate rotational force is applied to handle 8 to actuate circuit breaker 20. In Position A, cap teeth 15 mesh with gear teeth 13, and spring 4 biases gear teeth 13 away from engaging hub teeth 16. The angled shape of cap teeth 15 serve to interlock hub 1 and gear wheel 3 in one direction and provides slips in the other direction. These slips create a ratcheting mechanism between hub 1 and gear wheel 3 that allows for rotational movement in one direction when assembly 10 is not engaged.

As illustrated in FIG. 5, pulling handle 8 in an axial direction away from circuit breaker 20 forces handle assembly 10 into the interlocked position, referred to as Position B. As handle 8 is pulled, hub lip 9 compresses spring 4 towards gear ring 12. Gear teeth 13 are no longer coupled with cap teeth 15. Instead, gear teeth 13 mesh with hub teeth 16 (FIG. 2 and 2A) located on hub inner surface 7. In Position B, gear wheel 3 is engaged and interlocked with hub 1. To ease engagement between gear wheel 3 and hub 1, gear teeth 13 may comprise tapered portions 18 (FIG. 2B) and hub teeth 16 may comprise rounded portions 19 (FIG. 2A). Other tooth shapes may also be employed as long as gear teeth 13 are dimensioned and configured to mesh with hub teeth 16.

In Position B, handle 8 can be turned to rotate second handle assembly 10 in either rotational direction. Because gear wheel 3 is rigidly connected to actuator shaft 26 via setscrew 5, shaft 26 also responds to the rotation of handle 8 in either direction. When secondary handle assembly 10 is in Position B and rotated in one direction, circuit breaker 10 is actuated by actuator shaft 26. In other words, power to circuit breaker 20 and other electrical control equipment (not shown) in enclosure 30 is turned “on”. Alternatively, when secondary handle assembly 10 is in either Position A or Position B and rotated in the opposite direction, circuit breaker 10 is actuated by actuator shaft 26, and power is turned “off”.

In this way, operation of the secondary handle assembly 10 includes two-part movement. The first movement is in an axial direction, and the second movement is in a rotational direction. In the disconnected or unactuated position, secondary handle assembly 10 allows rotational movement in one direction. When secondary handle assembly 10 is in the actuated position, rotation is possible in both opposing rotational directions.

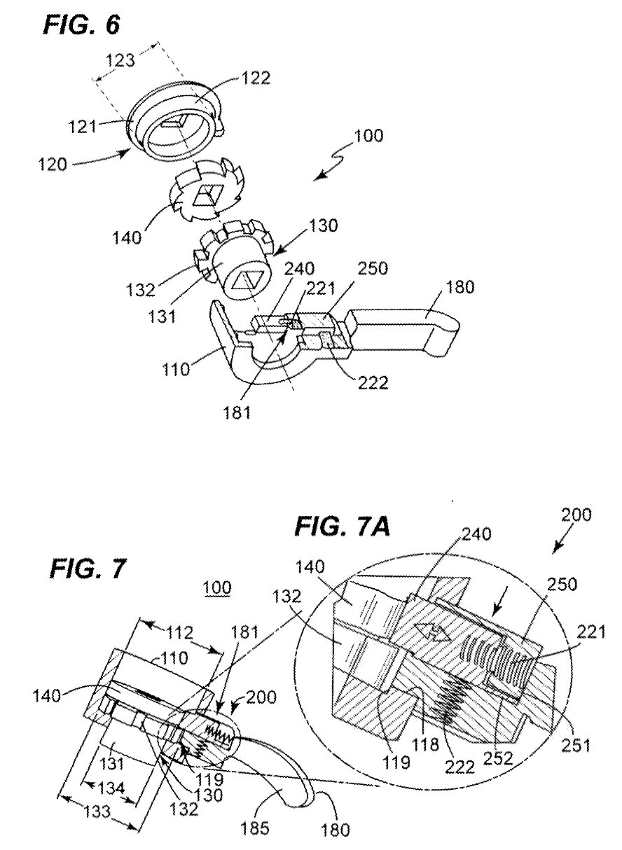

Referring now to FIG. 6, another embodiment of a secondary handle assembly in accordance with the present invention is shown generally at 100. In this embodiment, secondary handle assembly 100 comprises a ratchet 140. Similar to hub 1 described above, a hub 110 is provided which includes a handle 180 and a pawl assembly 181.

The secondary handle assembly also includes cap 120. Cap 120 comprises cap ring 121 and cap body 122. The outer diameter of cap ring 121 is larger than the outer diameter of cap body 122. Hub inner diameter 112 (FIG. 7) is slightly greater than or equal to cap body outer diameter 123 so that cap body 122 fits securely inside hub 110. However, hub inner diameter 112 is less than the outer diameter of cap ring 121 so that cap ring fits directly and securely on top of hub 110.

Gear wheel 130 comprises gear body 131 and gear ring 132. Illustrated in FIG. 7, gear ring outer diameter 133 larger than gear body outer diameter 134. Hub inner diameter 112 is slightly greater than or equal to gear ring outer diameter 133 so that gear ring 132 fits securely inside hub 110. Gear ring 132 acts as a shoulder against lip 119, which runs along the base of the hub inner surface. Lip 119 acts as a stop for gear ring 132. Lip 119 prevents gear ring 132 from slipping through the base of hub 110 and acts as an alignment portion for secondary handle assembly 10. Gear ring 132 is positioned inside the bore of hub 110 while gear body 131 fits through the bottom of hub 110.

Ratchet 140 fits securely between cap body 122 (not shown) and gear wheel 130. The outer diameters of ratchet 140, cap ring 121, and gear ring 132 may be equivalent.

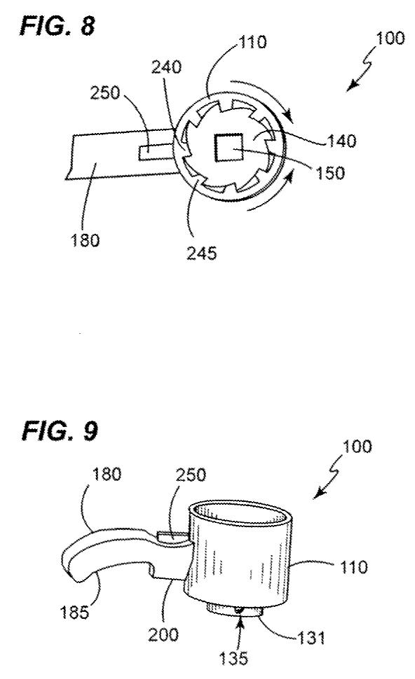

FIG. 8 shows a top view of secondary handle assembly 100. Ratchet 140 is assembled on top of gear wheel 130 so that the grooves of ratchet 140 and teeth of gear wheel 130 fit together to form a plurality of slots 245.

Shaft 26 (not shown) fits inside orifice 150 arranged by the matching apertures of cap 120, ratchet 140, and gear wheel 130 when secondary handle 100 is assembled. Shaft 26 is rigidly connected to gear wheel 3 with a setscrew (not shown). Aperture 135 for said setscrew can be seen in FIG. 9.

Referring to FIG. 7, handle 180 comprises gripping portion 185 and pawl assembly 181 comprises a button portion 200. Button portion 200 comprises a cavity and is positioned in between hub 100 and gripping portion 185, so that while holding handle 180, button 250 can be pushed easily.

FIG. 7A is an exploded image of button portion 200. Button portion 200 comprises compression springs 221 and 222, pawl 240, and button 250. Button 250 is also comprises a cavity. Button 250, pawl 240, and compression spring 221 run in a direction parallel to handle 180. Compression spring 221 connects button inside back surface 251 to pawl 240. Spring 221 fits inside a cut-out portion of pawl 240. Compression spring 222 runs perpendicular to handle 180 and connects button 250 with bottom inside surface of handle 180.

When secondary handle assembly 100 is not engaged, spring 221 is compressed, which enables spring 221 and part of pawl 240 to fit inside hollow button 250. This is the normal position or non-actuated position of secondary handle assembly 100.

The compression of spring 221 enables pawl 240 to be tightly engaged with a groove of ratchet 140. The coupling between pawl 240 and ratchet 140 creates a ratcheting mechanism between hub 110 and ratchet 140 that allows for movement in one direction. Spring 222 is not compressed in the non-actuated position. Compression spring 222 supports button 250 in the non-actuated position and keeps pawl 240 in alignment and engaged with ratchet 140. In other words, spring 222 biases pawl 240 away from engaging gear wheel 130.

Pressing button 250 forces the compression of spring 222. As spring 222 is compressed, pawl 240 slides down slot 245. As pawl 240 slides down slot 245, pawl 240 is forced out of engagement with ratchet 140. Spring 221 extends and forces pawl 240 to slide toward gear wheel 130 along button inside bottom surface 252 and into a tooth of gear wheel 130. When button 250 is pushed to stop portion 118, spring 222 is compressed and pawl 240 fully engaged with gear wheel 130. In this engaged or actuated position, handle 180 can be turned to rotate second handle assembly 100 in either opposing rotational directions.

Referring to FIG. 8, pawl 240 has a width less than or equal to the width of slot 245. This ensures that pawl 240 can slide easily through slot 245 and still tightly interlock with the gear teeth when second handle assembly 100 is engaged.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

1. A secondary handle assembly for a circuit breaker comprising an actuator shaft for actuating a circuit breaker, the actuator shaft extending through a circuit breaker cabinet and terminating at a primary handle assembly, the secondary handle assembly comprising:
a hub comprising a handle extending from the hub; and
a gear wheel comprising gear wheel teeth and a body fixable with the actuator shaft;
wherein the hub is configured to engage the gear wheel for rotational movement in one direction in an unactuated position and wherein the hub is further configured to engage the gear wheel for rotational movement in opposing rotational directions in an actuated position

2. The secondary handle assembly of claim 1, wherein the hub comprises a bore defined by a hub inner surface.

3. The secondary handle assembly of claim 2, further comprising hub teeth located on the hub inner surface.

4. The secondary handle assembly of claim 3, further comprising a spring for biasing the gear wheel teeth away from the hub teeth.

5. The secondary handle assembly of claim 1, further comprising a cap fixable with the hub.

6. The secondary handle assembly of claim 5, wherein the cap comprises cap teeth configured for meshing with the gear wheel teeth.

7. The secondary handle assembly of claim 6, wherein the cap teeth are angled to allow rotation of the handle assembly in one direction.

8. The secondary handle assembly of claim 5, wherein each of the cap, the hub the handle, and the gear wheel comprise a moldable and insulative substance from the group consisting of a polyamide, Polybutylene Terephthalate (PBT)/Polyethylene Terephthalate (PET)/Polycarbonate (PC) based resins, and moldable non-insulative metals with insulative coating.

9. The secondary handle assembly of claim 2, wherein the gear wheel comprises opposing terminal ends and a generally cylindrical outer configuration and the gear wheel teeth located at one of the terminal ends and extend in a radial direction from the body.

10. The secondary handle assembly of claim 9, wherein the gear wheel is disposed within the bore of the hub.

11. The secondary handle assembly of claim 9, wherein the gear wheel teeth comprise tapered ends configured for ease in meshing with the hub wheel teeth and the hub teeth comprise rounded ends.

12. The secondary handle assembly of claim 1, further comprising a ratchet.

13. The secondary handle assembly of claim 12, wherein the handle comprises a button portion comprising a button, a pawl, and a plurality of springs.

14. The secondary handle assembly of claim 13, wherein one spring enables the pawl to tightly engage the ratchet.

15. The secondary handle assembly of claim 14, wherein another spring biases the pawl from engaging the gear wheel teeth.

16. A method of actuating a circuit breaker comprising an actuator shaft using a secondary handle assembly comprising a hub comprising a handle extending from the hub and a gear wheel comprising a body secured to the actuator shalt and comprising gear wheel teeth, the method comprising:
rotating the handle whereby, the hub engages the gear wheel for rotational movement solely in one direction; and
rotating the handle while moving the handle in a linear direction whereby the hub engages the gear wheel for rotational movement in opposing rotational directions.

17. The method of claim 16, wherein the hub comprises hub teeth

18. The method of claim 17, further comprising biasing the gear wheel teeth away from the hub teeth.

19. The method of claim 16, wherein the hub comprises a ratchet and a pawl.

20. The method of claim 19, further comprising enabling the pawl to tightly engage the ratchet.

21. The method of claim 20, further comprising biasing the pawl away from the gear wheel teeth.
